(19) United States
(12) Patent Application Publication
(10) Pub. No.: US 2021/0289550 A1
(43) Pub. Date: Sep. 16, 2021

(54) METHOD OF TRANSMISSION IN UNLICENSED BAND AND NODE PERFORMING CLEAR CHANNEL ASSESSMENT

(71) Applicant: NTT DOCOMO, INC.

(72) Inventors: Le Liu, Tokyo (JP); Yuichi Kakishima, Tokyo (JP)

(73) Assignees: NTT DOCOMO, INC., Tokyo (JP); NTT DOCOMO, INC., Tokyo (JP)

(21) Appl. No.: 16/326,619

(22) PCT Filed: Aug. 21, 2017
(86) PCT No.: PCT/US2017/047801

§ 371 Date: Feb. 19, 2019

(51) Int. Cl. H04W 74/08; H04W 16/28; H04B 7/06; H04L 5/00

(52) U.S. Cl. CPC H04W 74/0816; H04L 5/0051; H04B 7/0626; H04W 16/28

(57) ABSTRACT

A method of transmission from a first node to a second node in an unlicensed band includes performing, with the first node, a directional clear channel assessment (CCA) to which a spatial filter is applied in the unlicensed band. The method further includes transmitting, from the first node to a second node, a signal after the first transceiver has performed the CCA. The spatial filter is applied to the signal. The method further includes transmitting, from the second node to the first node, capability information that indicates whether the second node is able to use spatial filtering. The method further includes notifying, with the first node, the second node of a resource to calculate the spatial filter in the second node.

### TECHNICAL FIELD

The present invention generally relates to a wireless communication method of transmission in an unlicensed band and a node performing clear channel assessment (CCA) (Listen-Before-Talk (LBT)) for transmission using the unlicensed band.

### BACKGROUND ART

Long Term Evolution Licensed-Assisted Access (LTE-LAA) or LTE-Unlicensed (LTE-U) utilizes unlicensed spectrum (band) to provide additional radio spectrum for mobile operators using LTE on licensed spectrum. As shown in FIG. 1, an LTE-LAA system, similar to a Wi-Fi system, is designed to use a Listen-Before-Talk (LBT) mechanism for fair sharing and coexistence without undue levels of interference from each other.

Conventional small cells in a Heterogeneous Network (HetNet) use periodic Discovery Reference Signal (RS) transmission of a Primary synchronization signal (PSS)/Secondary synchronization signal (SSS)/Cell-Specific Reference Signal (CRS)/Channel State Information Reference Signal (CSI-RS) to let user terminals access. However, as shown in FIGS. 2A and 2B, if the channel is busy due to the random interference from other Wi-Fi nodes, the transmission of discovery RS in the LAA system may be prevented. As a result, the user terminals cannot access to the LAA for data transmission.

### CITATION LIST

### Non-Patent Reference

Non-Patent Reference 1: 3GPP, TS 36.213 V 14.2.0

### SUMMARY OF THE INVENTION

According to one or more embodiments of the present invention, a method of transmission from a first node to a second node in an unlicensed band includes performing, with the first node, a directional clear channel assessment (CCA) to which a spatial filter is applied in the unlicensed band.

According to one or more embodiments of the present invention, a first node includes a processor that controls a directional clear channel assessment (CCA) to which a spatial filter is applied in an unlicensed band, and a transmitter that transmits a signal to a second node using the unlicensed band after the first transceiver has performed the CCA.

### BRIEF DESCRIPTION OF THE DRAWINGS

FIG. 1 is a diagram showing an example operation for transmission in a LTE-LAA system and a Wi-Fi system in a conventional scheme.

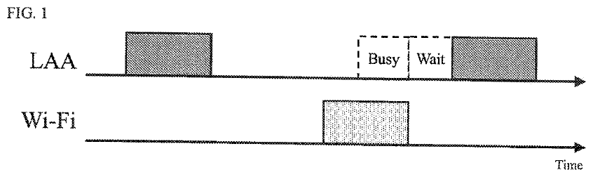

FIG. 2A is a diagram showing an example operation for Discovery RS transmission in a conventional scheme.

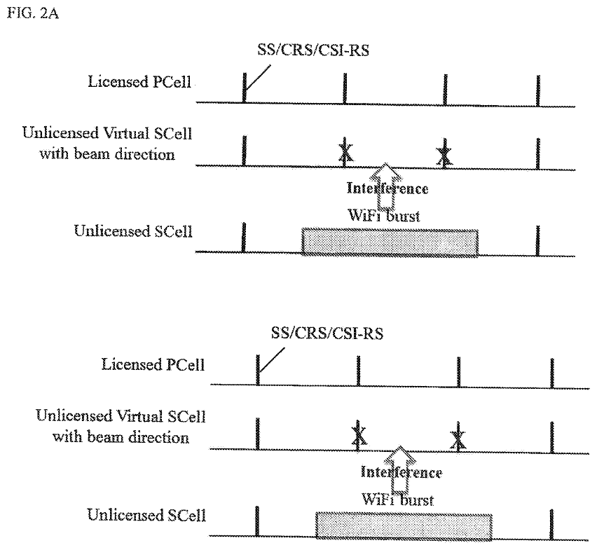

FIG. 2B is a diagram showing an example of a system configuration in a conventional scheme.

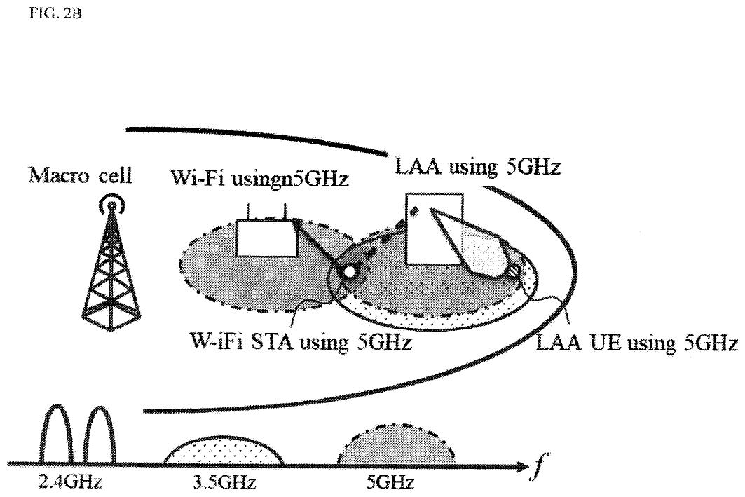

FIG. 3 is a diagram showing an example of a wireless communication system configuration according to one or more embodiments of a first example of the present invention.

FIG. 4 is a diagram showing an example operation for Discovery RS transmission according to one or more embodiments of the present invention.

FIG. 5 is a diagram showing an example of a resource configuration in a resource block according to one or more embodiments of a first example of the present invention.

FIG. 6 is a diagram showing an example of a resource configuration in a resource block according to one or more embodiments of a second example of the present invention.

FIG. 7 is a diagram showing Beam-specific RS pattern 1 according to one or more embodiments of the present invention.

FIG. 8 is a diagram showing Beam-specific RS pattern 2 according to one or more embodiments of the present invention.

### DETAILED DESCRIPTION OF EMBODIMENTS

Embodiments of the present invention will be described in detail below, with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

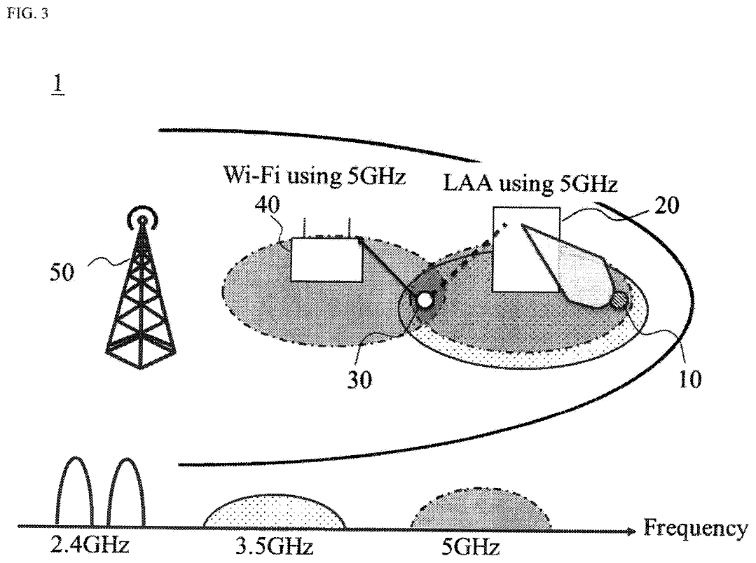

FIG. 3 is a diagram showing a wireless communication system 1 according to one or more embodiments of the present invention. The wireless communication system 1 includes a user equipment (UE) 10 that supports Licensed-Assisted Access (LAA), an LAA node 20, a Wi-Fi station (STA) 30, a Wi-Fi node 40, and a macro cell 50. The wireless communication system 1 may be designed to use a Listen-Before-Talk (LBT) mechanism The wireless communication system 1 may be an LTE-LAA system using unlicensed spectrum (band) in addition to licensed spectrum (band). The wireless communication system 1 is not limited to the specific configurations described herein and may be any type of wireless communication system such as a New Radio (NR) system.

The LAA node 20 may control at least a licensed cell and at least an unlicensed cell and communicate uplink (UL) and downlink (DL) signals with the UE(s) 10 using the licensed band (e.g., 3.5 GHz) the unlicensed band (e.g., 5 GHz). The DL and UL signals may include control information and user data. The LAA node 20 may communicate DL and UL signals with the core network through backhaul links. The LAA node 20 may be a base station an Evolved NodeB (eNB) or a gNodeB (gNB. The LAA node 20 may transmit a Primary synchronization signal (PSS)/Secondary synchronization signal (SSS), a Cell-Specific Reference Signal (CRS), and/or a Channel State Information Reference Signal (CSI-RS).

The LAA node 20 includes one or more antennas (transmitter and receiver), a communication interface to communicate with an adjacent LAA node 20 (for example, X2 interface), a communication interface to communicate with a core network (for example, 51 interface), and a CPU (Central Processing Unit) such as a processor or a circuit to process transmitted and received signals with the UE 10. Operations of the LAA node 20 may be implemented by the processor processing or executing data and programs stored in a memory. However, the LAA node 20 is not limited to the hardware configuration set forth above and may be realized by other appropriate hardware configurations as understood by those of ordinary skill in the art. Numerous LAA nodes 20 may be disposed so as to cover a broader service area of the wireless communication system 1.

The Wi-Fi node 40 may be a Wi-Fi router (Access Point (AP)) and communicate with the Wi-Fi STA 30 and the UE 10 using the unlicensed band (e.g., 5 GHz) based on the Institute of Electrical and Electronics Engineers (IEEE) 802.11 standards. For example, the Wi-Fi node 40 includes a CPU (or processor), a memory, and a transceiver.

The UE 10 may communicate DL and UL signals that include control information and user data with the LAA node 20 using the licensed band and the unlicensed band. The UE 10 may be a mobile station, a smartphone, a cellular phone, a tablet, a mobile router, or information processing apparatus having a radio communication function such as a wearable device. The UE 10 may communicate with the Wi-Fi node 40 based on the IEEE 802.11 standards. The wireless communication system 1 may include one or more UEs 10.

The UE 10 includes a CPU such as a processor, a RAM (Random Access Memory), a flash memory, and a radio communication device to transmit/receive radio signals to/from the LAA node 20 (Wi-Fi node 40) and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

The Wi-Fi STA 30 may be a station (terminal) that communicates with the Wi-Fi node 40 based on the IEEE 802.11 standards. For example, the Wi-Fi STA 30 includes a CPU (or processor), a memory, and a transceiver.

In one or more embodiments of the present invention, the LAA node 20 is an example of a first node and the UE 10 is an example of the second node. Furthermore, when the LAA node 20 is an example of a second node, the UE 10 may be an example of a first node.

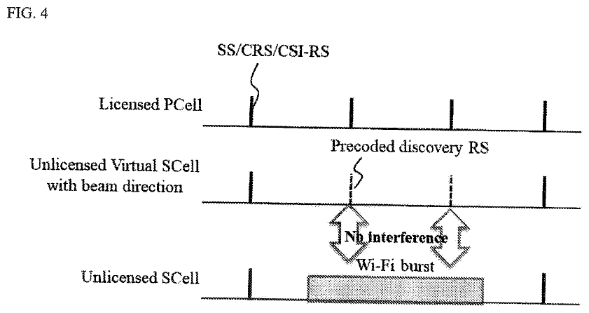

According to one or more embodiments of the present invention, as shown in FIG. 4, the LAA node 20 may estimate a direction of the interference by detecting the Wi-Fi transmissions. For example, clear channel assessment (CCA) may be performed based on energy detection with spatial filtering. Furthermore, the CCA may be performed based on packet detection of Wi-Fi Physical Layer Convergence Protocol (PLCP) Protocol Data Unit (PPDU) preamble.

According to one or more embodiments of the present invention, the LAA node 20 capable of beamforming may generate beamforming vector(s) to avoid the collision with concurrent Wi-Fi transmission in the unlicensed Secondary Cell (Scell). For example, the LAA node 20 may configure Transmission (Tx) power, antenna ports, Tx beam gain, beam-specific pattern, and candidate beams, etc.

According to one or more embodiments of the present invention, as shown in FIG. 4, the LAA node 20 may transmit reference signals (RSs) precoded by using the generated beamforming vector(s) to increase spatial reuse in the unlicensed virtual Scell. Furthermore, the LAA node 20 may transmit the DL precoded CSI-RS and the DL precoded CRS.

(Clear Channel Assessment at LAA Nodes)

According to one or more embodiments of the present invention, the LAA node 20 may perform a directional CCA in the unlicensed band and a spatial filter may be applied to the directional CCA. The LAA node 20 may transmit a signal to the UE 10 using the unlicensed band after the LAA node 20 has performed the CCA. For example, in the directional CCA, the LAA node 20 may measure an interference power value in the unlicensed band. Then, the LAA node 20 may transmit the signal when the measured interference power value is lower than a threshold power value. Furthermore, the spatial filter may be applied to the signal from the LAA node 20 after the CCA. The LAA node 20 may determine the threshold power value based on transmission power.

According to one or more embodiments of the present invention, the following two options may be applied to the CCA at the LAA nodes 20.

In the option 1, the CCA may be performed based on energy detection by using spatial filters to estimate the interference direction. The LAA nodes 20 using MIMO technologies may flexibly configure multiple receiving spatial filters. In one or more embodiments of the present invention, when the transmission power is high, the accurate may be required. For example, the LAA node 20 may determine the threshold power value using an offset value of the transmission value when the transmission power is high. On the other hand, when the transmission power is low, the CCA may be performed roughly.

In the option 2, the CCA may be performed based on packet detection of Wi-Fi PPDU preamble.

Legacy Short Training Field (STF)/Long Training Field (LTF)/Signal Field (SIG) for IEEE 802.11a PPDU

Legacy STF/LTF/SIG+HT-STF/LTF for IEEE 802.11n PPDU

Legacy STF/LTF/SIG+VHT-STF/LTF for IEEE 802.11ac PPDU

Legacy STF/LTF/SIG+HE-STF/LTF for IEEE 802.11ax PPDU

The estimated Channel State Information (CSI) may be used to generate precoding RS with minimized interference. Furthermore, the PPDU length indicated in L-SIG may be used to set the duration of precoded RS.

### First Example

Embodiments of a first example of the present invention will be described below. According to one or more embodiments of the first example of the present invention, the precoded downlink (DL) CSI-Reference Signal (CSI-RS) may be configured as a discovery signal.

At a transmitter side, the LAA node 20 may inform the signaling including

CSI-RS on/off;

CSI-RS Tx power;

CSI-RS bandwidth;

Number of CSI-RS antenna ports;

CSI-RS antenna port index;

CSI-RS Subframe configuration: periodicity, subframe offset;

CSI-RS configuration: resource element location per RB;

Tx beam gain;

Beam-specific pattern: configuration of power, sequence, etc.; and

Candidate precoding vector(s) (long-term and/or short-term).

At a receiver side, the UE 10 may measure large-scale CSI such as Reference Signal Received Power (RSRP)/Reference Signal Received Quality (RSRQ) and/or small-scale CSI on the precoded CSI-RS. The UE 10 may estimate the path loss with the scaled Tx power and beam gain. The UE 10 should not average the measurement based on different precoded CSI-RSs. Furthermore, the UE 10 may transmit, to the LAA node 20, capability information that indicates whether the UE 10 is able to use spatial filtering

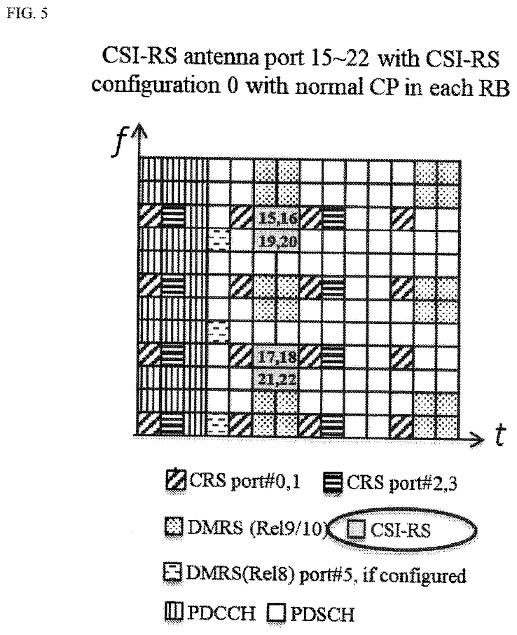

Furthermore, FIG. 5 is a diagram showing an example of a resource configuration in a resource block (RB) according to one or more embodiments of the first example of the present invention. FIG. 5 shows CSI-RS antenna ports 15-22 with CSI-RS configuration 0 with normal CP in each RB.

### Second Example

Embodiments of a second example of the present invention will be described below. According to one or more embodiments of the second example of the present invention, the precoded DL CRS is configured as the discovery signal.

At the transmitter side, the LAA node 20 may inform the signaling including:

CRS Tx power;

CRS bandwidth;

Number of CRS antenna ports;

CRS antenna port index;

CRS Subframe configuration: periodicity, subframe offset;

Tx beam gain;

Beam-specific pattern: configuration of power, sequence, etc.; and

Candidate precoding vector(s) (long-term and/or short-term).

At the receiver side, the UE 10 may measure large-scale CSI such as RSRP/RSRQ and/or small-scale CSI on the precoded CRS. The UE 10 may estimate the path loss with the scaled Tx power and beam gain. The UE 10 should not average the precoded CRS measurement with non-precoded CRS measurement.

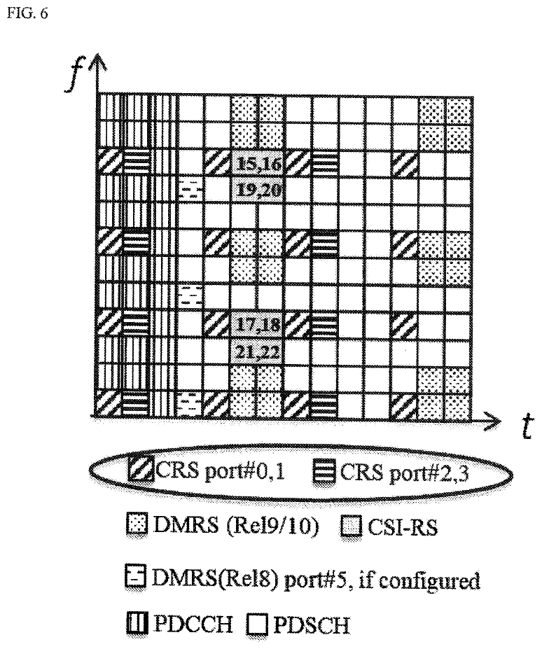

FIG. 6 is a diagram showing an example of a resource configuration in a resource block according to one or more embodiments of a second example of the present invention.

(Beam-Specific Pattern)

According to one or more embodiments of the present invention, the following two patterns may be applied to the beam-specific pattern.

(Illustration of Beam-Specific Pattern 1)

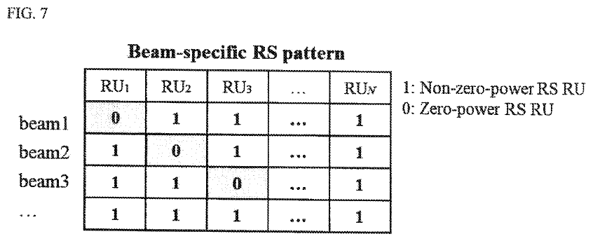

To avoid collision with random interference, a dynamic beamforming configuration may be required. Furthermore, in an illustration of beam-specific pattern 1, as shown in FIG. 7, the beam-specific DL RS pattern may be defined to cause the UEs 10 to differentiate a large number of beams based on the power configuration.

A Non-zero-power (NZP) Precoded RS is configured for different beams. The same cell ID is shared by a group of beams on the same RS resources. A Zero-power (ZP) RS is used to identify respective beams. In such a case, the UEs 10 may detect/select the best beam(s) based on energy detection.

(Illustration of Beam-Specific Pattern 2)

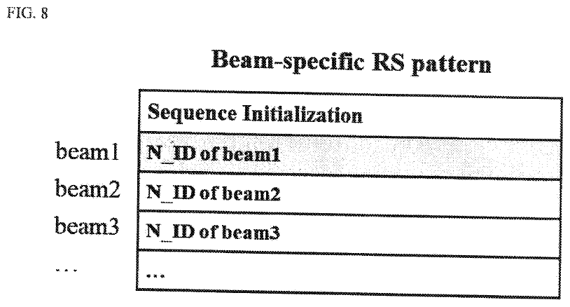

To avoid collision with random interference, a dynamic beamforming configuration may be required. Furthermore, in an illustration of beam-specific pattern 2, as shown in FIG. 8, the beam-specific DL RS pattern may be defined to cause the UEs 10 to differentiate a large number of beams based on the sequence configuration. Different sequences with good correlation are configured for different beams. The same cell ID is shared by a group of beams on the same RS resources. In such a case, the UEs 10 may detect the best beam(s) based on correlation detection.

In one or more embodiments of the present invention, the LAA system may use the precoded DL RS to minimize the collision interference with the Wi-Fi transmission in the unlicensed band. As a result, the spectrum efficiency of LAA may be improved by increasing spatial reuse. Furthermore, accurate measurement/feedback at UE 10 may be achieved with simple user behavior. Tx power can be saved by using beamforming gain while keeping similar coverage as that without beamforming. Good backward compatibility with LTE in licensed band may be realized.

### Another Example

As another example, precoded transmission of DL synchronization signals may be used based on the detected interference direction.

As another example, one or more embodiments of the present invention may be applied on an uplink RS based on the interference detection at the UEs 10.

As another example, precoded transmission of control channel may be used based on the detected interference direction.

As another example, precoded transmission of control channel may be used based on the detected interference direction.

Although the present disclosure mainly described examples of a channel and signaling scheme based on LTE/LTE-A, the present invention is not limited thereto. One or more embodiments of the present invention may apply to another channel and signaling scheme having the same functions as LTE/LTE-A, New Radio (NR), and a newly defined channel and signaling scheme.

The above examples and modified examples may be combined with each other, and various features of these examples can be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### EXPLANATION OF REFERENCES

1 Wireless Communication System
10 User Equipment (UE)
20 LAA Node
30 Wi-Fi Station
40 Wi-Fi Node

What is claimed is:

1. A method of transmission from a first node to a second node in an unlicensed band, the method comprising:
performing, with the first node, a directional clear channel assessment (CCA) to which a spatial filter is applied in the unlicensed band.

2. The method according to claim 1, further comprising:
transmitting, from the first node to a second node, a signal after the first transceiver has performed the directional CCA.

3. The method according to claim 2, wherein the spatial filter is applied to the signal.

4. The method according to claim 2, further comprising:
measuring, with the first node, an interference power value in the unlicensed band in the directional CCA,
wherein the transmitting transmits the signal when the measured interference power value is lower than a threshold power value.

5. The method according to claim 4, further comprising:
determining, with the first node, the threshold power value based on transmission power.

6. The method according to claim 5, wherein the determining determines the threshold power value using an offset value of the transmission power.

7. The method according to claim 1, further comprising:
transmitting, from the second node to the first node, capability information that indicates whether the second node is able to use spatial filtering.

8. The method according to claim 1, further comprising:
notifying, with the first node, the second node of a resource to calculate the spatial filter in the second node.

9. The method according to claim 1, further comprising:
calculating, with the first node, the spatial filter based on a Wi-Fi Protocol Data Unit (PPDU) preamble.

10. The method according to claim 1, further comprising:
transmitting, from the first node to the second node, Channel State Information-Reference Signals (CSI-RSs);
receiving, with the first node, CSI feedback information including an estimated CSI from the second node in response to the CSI-RSs; and
generating, with the first node, a precoded reference signal (RS) based on the estimated CSI.

11. The method according to claim 8, wherein the generating generates the precoded RS of which duration is determined based on Physical Layer Convergence Protocol (PLCP) Protocol Data Unit (PPDU) length.

12. A first node comprising:
a processor that performs a directional clear channel assessment (CCA) to which a spatial filter is applied in an unlicensed band; and
a transmitter that transmits a signal to a second node using the unlicensed band after the first transceiver has performed the CCA.

13. The first node according to claim 12, wherein the spatial filter is applied to the signal.

14. The first node according to claim 12,
wherein the processor measures an interference power value in the unlicensed band in the directional CCA, and
wherein the transmitter transmits the signal when the measured interference power value is lower than a threshold power value.

15. The first node according to claim 14, further comprising:
wherein the processor determines the threshold power value based on transmission power.

16. The first node according to claim 12, further comprising:
a receiver that receives capability information that indicates whether the second node is able to use spatial filtering.

17. The first node according to claim 12, wherein the transmitter transmits, to the second node, information indicating a resource to calculate the spatial filter in the second node.

18. The first node according to claim 12, wherein the processor calculates the spatial filter based on a Wi-Fi Physical Layer Convergence Protocol (PLCP) Protocol Data Unit (PPDU) preamble.

19. The first node according to claim 12, further comprising:
a receiver,
wherein the transmitter transmits Channel State Information-Reference Signals (CSI-RSs) to the second node,
wherein the receiver receives CSI feedback information including an estimated CSI from the second node in response to the CSI-RSs, and
wherein the processor generates a precoded reference signal (RS) based on the estimated CSI.

20. The first node according to claim 19, wherein the processor generates the precoded RS of which duration is determined based on Physical Layer Convergence Protocol (PLCP) Protocol Data Unit (PPDU) length.
